(19) United States
(12) Patent Application Publication
(10) Pub. No.: US 2003/0222523 A1
(43) Pub. Date: Dec. 4, 2003

(54) Spindle motor stator magnet axial bias

(76) Inventors: Jim-Po Wang, Pleasanton, CA (US); Paco Flores, Felton, CA (US)

Correspondence Address: MOSER, PATTERSON & SHERIDAN, LLP, Suite 250, 350 Cambridge Avenue, Palo Alto, CA, 94306, US

(21) Appl. No.: 10/340,048

(22) Filed: Jan. 10, 2003

Related U.S. Application Data
(60) Provisional application No. 60/383,993, filed on May 28, 2002.

(51) Int. Cl. H02K 5/16; H02K 7/08

(52) U.S. Cl. 310/90

(57) ABSTRACT

The present invention relates to the field of fluid dynamic bearings. Specifically, the present invention provides an apparatus and method useful for constraining axial movement of a motor hub in a high speed spindle motor assembly.

### CROSS REFERENCE TO A RELATED APPLICATION

This application claims priority to provisional application Serial No. 60/383,993, filed May 28, 2002, entitled “Spindle Motor Stator/Magnet Axial Bias” invented by Jim-Po Wang and Paco Flores, and incorporated herein by reference.

### FIELD OF THE INVENTION

The present invention relates to the field of computer disk drives, specifically, those having fluid dynamic bearings.

### BACKGROUND OF THE INVENTION

Disk drive memory systems have been used in computers for many years for the storage of digital information. Information is recorded on concentric tracks of a magnetic disk medium, the actual information being stored in the forward magnetic transitions within the medium. The disks themselves are rotatably mounted on a spindle. Information is accessed by a read/write transducer located on a pivoting arm that moves radially over the surface of the rotating disk. The read/write heads or transducers must be accurately aligned with the storage tracks on the disk to ensure proper reading and writing of information.

During operation, the disks are rotated at very high speeds within an enclosed housing using an electric motor generally located inside a hub or below the disks. Such spindle motors may have a spindle mounted by two ball bearing systems to a motor shaft disposed in the center of the hub. The bearing systems are spaced apart, with one located near the top of the spindle and the other spaced a distance away. These bearings allow support the spindle or hub about the shaft, and allow for a stable rotational relative movement between the shaft and the spindle or hub while maintaining accurate alignment of the spindle and shaft. The bearings themselves are normally lubricated by highly refined grease or oil.

The conventional ball bearing system described above is prone to several shortcomings. First is the problem of vibration generated by the balls rolling on the bearing raceways. This is one of the conditions that generally guarantees physical contact between raceways and balls, in spite of the lubrication provided by the bearing oil or grease. Bearing balls running on the microscopically uneven and rough raceways transmit the vibration induced by the rough surface structure to the rotating disk. This vibration results in misalignment between the data tracks and the read/write transducer, limiting the data track density and the overall performance of the disk drive system. Further, mechanical bearings are not always scalable to smaller dimensions. This is a significant drawback, since the tendency in the disk drive industry has been to shrink the physical dimensions of the disk drive unit.

As an alternative to conventional ball bearing spindle systems, much effort has been focused on developing a fluid dynamic bearing (FDB). In these types of systems, lubricating fluid, either gas or liquid, functions as the actual bearing surface between a shaft and a sleeve or hub. Liquid lubricants comprising oil, more complex fluids, or other lubricants have been utilized in such fluid dynamic bearings.

The reason for the popularity of the use of such fluids is the elimination of the vibrations caused by mechanical contact in a ball bearing system and the ability to scale the fluid dynamic bearing to smaller and smaller sizes. In designs such as the single plate FDB, two thrust surfaces generally are used to maintain the axial position of the spindle/motor shaft assembly. Such a configuration maintains axial position; however, this configuration does not aid in reducing the power required by the FDB at start up.

In such designs, the changing viscosity of the fluid with changing operating temperature of the bearing and/or motor imposes a significant restraint on available designs. As the temperature changes, the power required to spin the motor will vary—if the gap remains constant; further, the stiffness of the system will diminish as the system heats and fluid viscosity diminishes.

Another approach to assure axial position of the spindle/motor shaft assembly and to address varying viscosity of the fluid is to remove one of the thrust surfaces from the FDB and replace it with a magnetic force to constrain the motor's axial movement. This typically involves adding a magnetic circuit to the assembly consisting of a magnet fixed to the hub, sleeve or base that attracts (or repels) the facing motor hub, sleeve or base. Though effective, this additional magnetic configuration requires additional parts, machining and assembly.

Other efforts to address the problems of axial positioning and fluid viscosity have included using different metals in the shaft and sleeve so that the gap would change with changes in temperature; however, such solutions are typically relatively expensive. Accordingly, it would be advantageous to design a disk drive assembly that maintains axial positioning which minimizing the power required at start-up and constant speed rotation even as the viscosity of the fluid undergoes substantial changes.

Thus, there is an interest in the art to assure proper axial positioning of the spindle/motor shaft assembly and reduce the power required at start up without additional parts, machining and assembly.

### SUMMARY OF THE INVENTION

The present invention is intended to provide reduced power in a fluid dynamic bearing assembly and constrained axial movement of the motor hub, without additional parts or re-design of currently used parts.

These and other advantages and objectives are achieved by providing a fluid bearing design where a fluid bearing supports the shaft for rotation, with its positioning being axially compensated by a magnetic preload. By this combination, as the motor speeds up and heats up, which otherwise would cause the fluid pressure in the bearing gap to change, the magnetic preload maintains the pressure in the fluid between relatively rotating rotor and stator.

In a first exemplary embodiment, the shaft is supported for rotation by a bearing rotating within a sleeve and upon a counter plate. To prevent misalignment of the rotor and stator as the motor heats up and fluid viscosity changes and to prevent upward movement of the shaft due to an upward force while spinning, a magnetic preload is established; in a preferred embodiment, the magnetic preload is achieved using a stator magnet offset with the stator.

Thus, the present invention provides a fluid dynamic bearing comprising a sleeve and a shaft supported for rotation within the sleeve and upon a counter plate. The shaft supports a hub at one end for rotation with the shaft, has an outer surface facing an inner surface of the sleeve, and a bottom surface adjacent to a counter plate. Either the outer surface of the shaft or the sleeve has a set of grooves defined thereon. Also, either the bottom surface of the shaft or the top surface of the counter plate has a set of grooves defined thereon. The shaft further is supported for rotation relative to the sleeve by fluid in a gap between the shaft and the sleeve and the shaft and the counter plate. In addition, there is a stator supported on an outer surface of the sleeve. A stator magnet is supported on an inner surface of the hub and is offset vertically relative to the stator. The shaft is axially biased by the stator magnet being vertically offset to the stator. In addition, there is a base supporting the sleeve.

In sum, according to the present arrangement, proper axial position of the spindle/motor shaft assembly is maintained and power is reduced even as the temperature changes.

It can further be seen that the design will be relatively easy to assemble requiring simply a vertical offset of the stator with the stator magnet.

### BRIEF DESCRIPTION OF THE DRAWINGS

For a fuller understanding of the present invention, reference is made to the accompanying drawings in the following detailed description.

FIG. 1 illustrates an example of a magnetic disk drive in which the invention may be employed;

FIG. 2 is a vertical sectional view of a prior art constant pressure magnetic preload fluid dynamic bearing;

FIG. 3 is a vertical sectional view of an embodiment of the magnetically compensated constant pressure fluid dynamic bearing of the present invention; and

FIG. 4A shows the configuration of a stator/magnet offset; and FIG. 4B is a graph showing test results of rotor axial force versus magnet/stator offset.

### DESCRIPTION OF THE PREFERRED EMBODIMENTS

Reference will now be made in detail to exemplary embodiments of the invention, examples of which are illustrated in the accompanying drawings. While the invention will be described in conjunction with these embodiments, it is to be understood that the described embodiments are not intended to limit the invention solely and specifically to only those embodiments, or to use the invention solely in the disk drive which is illustrated. On the contrary, the invention is intended to cover alternatives, modifications and equivalents that may be included within the spirit and scope of the invention as defined by the attached claims. Further, both hard disk drives and spindle motors are both well known to those of skill in this field. In order to avoid confusion while enabling those skilled in the art to practice the claimed invention, this specification omits such details with respect to known items.

The embodiments of the present invention are intended to minimize power consumption and maintain stability of the rotating hub. The problem is complicated by the fact that the relative rotation of hub/sleeve/shaft combinations is typically supported by fluid whose viscosity changes with temperature. Moreover, the power consumption also changes with the change in viscosity of the fluid. At low temperature the viscosity is high and the power consumption is also relatively high. The larger the grooved areas, the greater the power consumption. The power consumption and also stiffness change with the width of the gap in which the bearing is established. In typical designs, the gap is constant, and therefore the power consumption and stiffness vary as the viscosity of the fluid changes. In addition, axial positioning of the spindle assembly must be maintained to reduce power and maintain fidelity of the system.

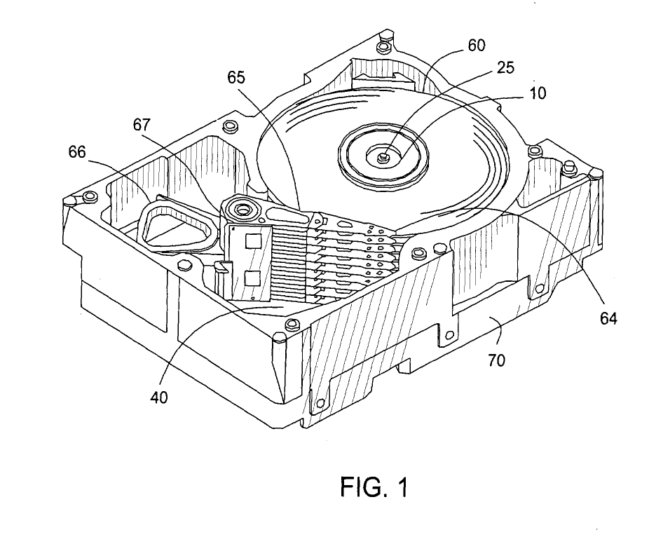

FIG. 1 illustrates an example of a magnetic disk drive in which the invention may be employed. At least one magnetic disk 60 having a plurality of concentric tracks for recording information is mounted on a spindle 10. The spindle is mounted on spindle support shaft 25 for rotation about a central axis. As the disks are rotated by the motor, a transducer 64 mounted on the end of an actuator end 65 is selectively positioned by a voice coil motor 66 rotating about a pivot axis 67 to move the transducer 64 from track to track across the surface of the disk 60. The elements of the disk drive are mounted on base 40 in a housing 70 that is typically sealed to prevent contamination (a top or cover of housing 70 is not shown). The disks 60 are mounted on spindle 10.

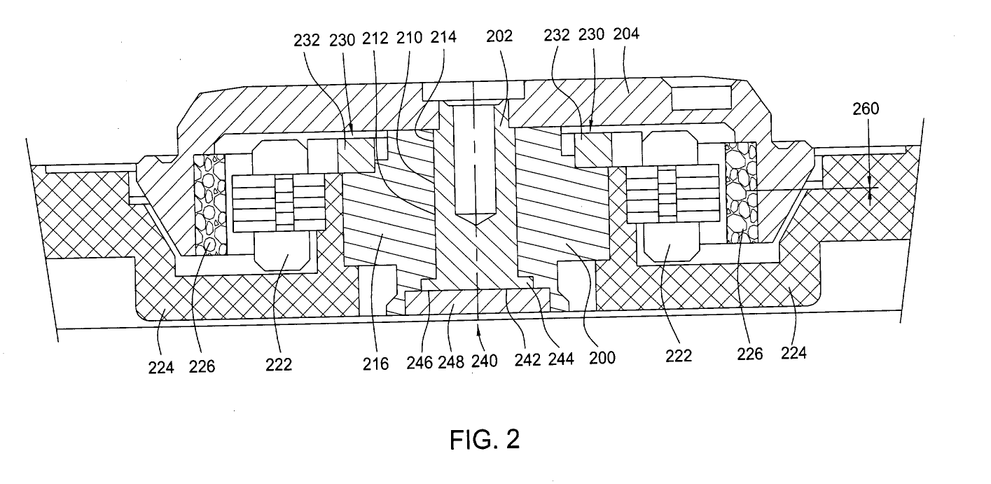

FIG. 2 shows a fluid bearing comprising a sleeve 200 and a shaft 202 supporting a hub 204 for rotation. The hub supports one or more disks (not shown). The design includes a fluid dynamic bearing 210 comprising a gap between the outer surface 212 of shaft 202 and the inner surface 214 of sleeve 200. One of those two surfaces has grooves to maintain the pressure of a fluid 216 maintained in this gap to support the relative rotation of the shaft and sleeve. In addition, there is an additional fluid dynamic bearing 242 comprising a gap between the bottom 244 of the shaft 202, and the top 246 of counter plate 248. One of the bottom surface 244 of shaft 202 or the top 246 of counter plate 246 also has grooves to maintain pressure of fluid 216 maintained in the gap.

The design shown includes a stator 222 supported on the outer surface of the base 224, and cooperating with stator magnet 226 so that appropriate energization of the stator causes high speed rotation of the hub 204 and therefore the disks. Stator 222 and stator magnet 226 are level vertically at their respective midpoints 260. A biasing magnet or magnet preload 232 is mounted on an axially facing surface of the sleeve 220. This is an approach known in the art used to establish a magnetic axial bias against the shaft; that is, to axially position the shaft 202 relative to sleeve 200.

The directional force of the system when in operation without magnetic biasing is shown at 240. Spinning of the shaft with the fluid dynamic bearings 210 and 242 imposes an upward directional force that can misalign the assembly. Magnet preload 232 prevents such misalignment.

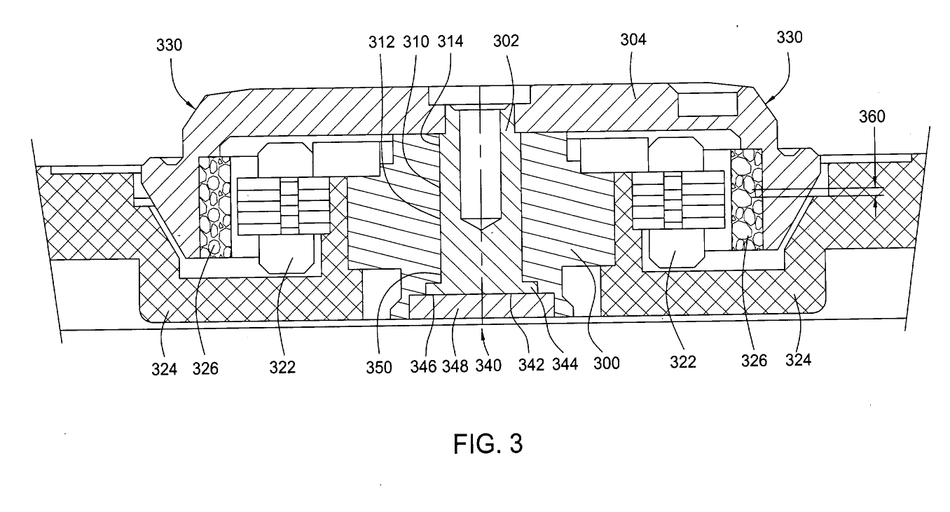

FIG. 3 shows a fluid bearing comprising a sleeve 300 and a shaft 302 supporting a hub 304 for rotation in which the design is modified to maintain stiffness with changes in viscosity. The hub 304 supports one or more disks (not shown). The design includes a fluid dynamic bearing 310 comprising a gap between the outer surface 312 of shaft 302 and the inner surface 314 of sleeve 300. One of those two surfaces has grooves to maintain the pressure of a fluid 316 maintained in this gap to support the relative rotation of the shaft and sleeve. It should be recognized that although conical-shaped bearing are shown, bearing of other shapes and/or configurations may be used as well.

In addition, there is an additional fluid dynamic bearing 342 comprising a gap between the bottom 344 of the shaft 302, and the top 346 of counter plate 348. One of the bottom surface 344 of shaft 302 or the top 346 of counter plate 346 has grooves to maintain pressure of fluid 316 in the gap.

The directional force of the system when in operation without magnetic biasing is shown at 340. Spinning of the shaft with the fluid dynamic bearings 310 and 342 imposes an upward directional force that can misalign the assembly. A magnet preload prevents such misalignment.

The design shown includes a stator 322 supported on the outer surface of the base 324, and cooperating with stator magnet 326 so that appropriate energization of the stator causes high speed rotation of the hub 304 and, therefore, the disks. However, in the present embodiment, an additional biasing magnet is not required (see magnet 232 of FIG. 2). Instead, the stator magnet 326 is offset vertically from the stator 322 (at 360). This approach establishes a magnetic axial bias against the shaft using the stator magnet; that is, the stator magnet not only energizes the stator to cause rotation of the hub 304, but the stator magnet additionally serves the purpose of axially positioning the shaft 302 relative to sleeve 300 without the addition of additional magnet to the disk drive assembly.

Once the axial bias is established, as the temperature changes and the viscosity of the fluid changes, the fluid bearing gap will adjust so that the axial force across the gap remains substantially stable with changes in temperature. Further, with the use of the FDB conical design, which provides both axial and radial support for the relatively rotating parts, good misalignment stiffness is established.

It is necessary to calibrate the axial bias due to the offset of stator magnet 326 to establish and maintain the pressure in the gap 312 with changes in temperature of the fluid so that the fluid bearing is properly temperature compensated. To reproduce the motor in high volume production, the gap 312 should be set accurately so that by utilizing the offset stator magnet 326, a constant force can be established, which in turn establishes the parameters for the rest of the motor so that a constant force is established across the bearing gap.

It should be noted that in this particular embodiment, a further fluid bearing 350 is defined between the outer surface of the shaft 302 and the inner surface of the sleeve 300. This bearing is defined using well-established technology, imposing grooves on either the outer surface of the shaft or the 302 or the inner surface of sleeve 300 with fluid in the gap supporting the relative rotation of the shaft and sleeve.

### EXAMPLE

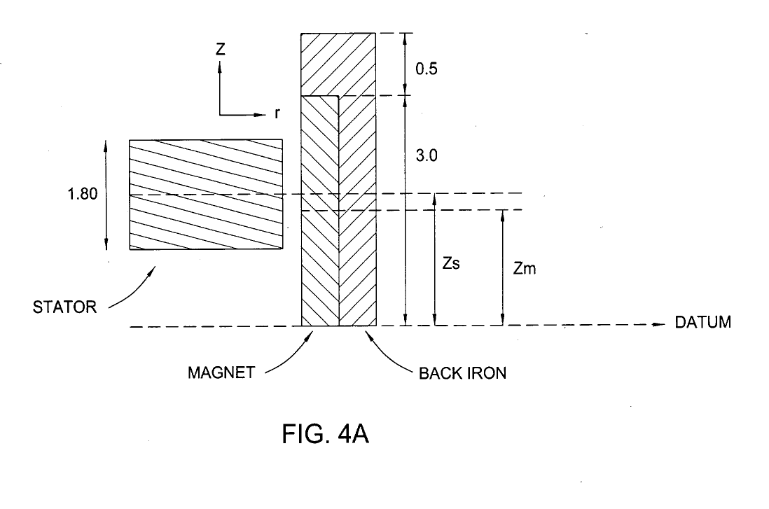

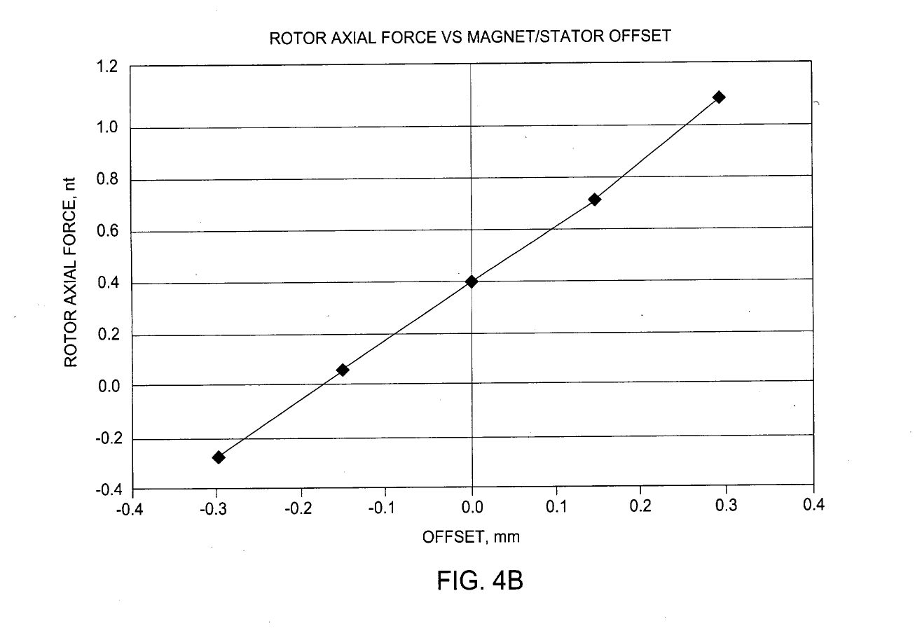

FIG. 4A shows the configuration of a stator/magnet offset, where offset is equal to Zs−Zm. Zm is half magnet height from Datum and Zs is half stator height from Datum. FIG. 4B is a graph showing rotor axial force versus magnet/stator offset for a particular stator/magnet configuration, though one skilled in the art will note that the actual value for magnet offset will vary on the size and strength of the stator and the magnet used.

Other features and advantages of the invention will become apparent to a person of skill in the art who studies the following disklosure of preferred embodiments.

What is claimed is:

1. A fluid dynamic bearing comprising a sleeve, a counter plate, a shaft supported for rotation within the sleeve and upon the counter plate, the shaft supporting at one end a hub for rotation with the shaft, a stator supported on an outer surface of the sleeve, a stator magnet supported on an inner surface of the hub and offset vertically relative to the stator, a base supporting the sleeve; wherein the shaft has an outer surface facing an inner surface of the sleeve, one of the shaft and sleeve having a set of grooves defined thereon; wherein the shaft has a bottom surface facing an upper surface of the counter plate, one of the shaft and the counter plate having a set of grooves defined thereon; and wherein the shaft is supported for rotation relative to the sleeve and counter plate by fluid in a gap between the shaft and the sleeve and the shaft and the counter plate, and the shaft is axially biased by a force established by the stator magnet being axially offset to the stator.

2. A fluid dynamic bearing as claimed as claim 1 wherein the axial bias is set to impose a constant load on the fluid dynamic bearing to compensate for the changing viscosity of the fluid in the gap between the shaft and the sleeve and the shaft and the counter plate.

3. A fluid dynamic bearing as claimed in claim 1 wherein the offset between the stator magnet and the stator is set to establish a substantially constant axial pressure in the conical bearing over changes in temperature.

4. A fluid dynamic bearing as claimed as claim 1, wherein a mid-point of the stator magnet is offset above a mid-point of the stator.

5. A fluid dynamic bearing as claimed as claim 4, wherein the offset is about 0.2 mm.

6. A constant load fluid dynamic bearing comprising a sleeve and counter plate, a shaft supported for rotation within the sleeve and upon a counter plate, the shaft supporting at one end a hub for rotation with the shaft, a stator supported on an outer surface of the sleeve, a base supporting the sleeve and further supporting a stator magnet offset with a stator; wherein the shaft has an outer surface facing an inner surface of the sleeve, one of the shaft and sleeve having a set of grooves defined thereon; wherein the shaft has a bottom surface facing an upper surface of the counter plate, one of the shaft and the counter plate having a set of grooves defined thereon; the shaft being supported for rotation relative to the sleeve and counter plate by fluid in a gap between the shaft and the sleeve, the shaft and the counter plate and the hub and the sleeve, the shaft being axially biased by a force established by the stator magnet being axially offset to the stator.

7. A constant load fluid dynamic bearing as claimed in claim 6 further comprising a variable gap thrust bearing at an end distal from the base, the thrust bearing being defined by a gap between an axially facing surface of the hub and an opposing axially facing surface of the sleeve wherein fluid in the gap supports relative rotation of the hub to the sleeve.

8. A constant load fluid dynamic bearing as claimed in claim 7 further comprising a journal bearing defined by a gap in fluid communication with the gap of the thrust bearing, the gap of the journal bearing being defined by a radially facing surface of the sleeve and an opposing radially facing surface of the shaft, relative rotation of the shaft relative to the sleeve being supported by fluid in the journal bearing gap.

9. A constant load fluid dynamic bearing as claimed as claim 6, wherein a mid-point of the stator magnet is offset above a mid-point of the stator.

10. A constant load fluid dynamic bearing as claimed as claim 9, wherein the offset is about 0.2 mm .

11. A constant load fluid dynamic bearing as claimed in claim 6 wherein the fluid changes in viscosity with change in temperature, and the magnet is offset to the stator so that as the viscosity changes and the thrust gap changes, the fluid pressure in the thrust bearing is maintained substantially constant.

12. In a disk drive comprising a housing including a base and a cover to define an enclosed space: a spindle motor comprising a sleeve defining a bore; a shaft supporting at one end a hub adapted to support one or more disks for constant speed rotation and adjacent to a counter plate at an end distal from the hub; fluid bearing means for the shaft to support rotation relative to the sleeve and the counter plate; and a stator magnet offset with a stator for establishing a force for axially biasing the shaft relative to the sleeve and counter plate to maintain substantially constant fluid pressure in the fluid bearing means with changes in viscosity of the fluid.

13. A disk drive as claimed in claim 12 wherein a shaft outer surface includes a generally conical surface facing an inner surface of the sleeve, the fluid bearing means including fluid in a gap defined by the generally conical surface.

14. A disk drive as claimed as claim 12, wherein an axial mid-point of the stator magnet is axially offset from a mid-point of the stator.

15. A disk drive as claimed in claim 14 wherein the offset is about 0.2 mm.

16. A bearing as claimed in claim 12 wherein the shaft and counter plate further define a thrust bearing, the thrust bearing being defined by a set of grooves on one of a bottom surface of the shaft or a top surface of the counter plate and including fluid in a gap defined by the bottom surface of the shaft and the top surface of the counter plate.

17. A disk drive as claimed in claim 16 wherein the fluid bearing means comprises a journal bearing cooperating with the thrust bearing.

18. A method for axially biasing a spindle motor assembly having a fluid dynamic bearing comprising the step of vertically offsetting a stator magnet in relation to a stator.

19. The method of claim 18, wherein a mid-point of the stator magnet is offset above a mid-point of the stator.

20. The method of claim 19, wherein the offset is 0.2 mm.
